(19) United States
(12) Patent Application Publication
(10) Pub. No.: US 2009/0323802 A1
(43) Pub. Date: Dec. 31, 2009

(54) COMPACT CAMERA-MOUNTABLE VIDEO ENCODER, STUDIO RACK-MOUNTABLE VIDEO ENCODER, CONFIGURATION DEVICE, AND BROADCASTING NETWORK UTILIZING THE SAME

(76) Inventors: Clifford A. Walters, Redlands, CA (US); Chad Walters, Los Angeles, CA (US)

Correspondence Address: CHRISTIE, PARKER & HALE, LLP, PO BOX 7068, PASADENA, CA, 91109-7068, US

(21) Appl. No.: 12/494,176

(22) Filed: Jun. 29, 2009

Related U.S. Application Data
(60) Provisional application No. 61/076,597, filed on Jun. 27, 2008.

(51) Int. Cl. H04N 11/02

(52) U.S. Cl. 375/240.01; 375/E07.026

(57) ABSTRACT

A turn-key solution is provided for the live Internet audio/video broadcasting and the transferring of previously recorded material. A system shares audio/video data over a network by utilizing a compact, camera-mountable video/audio encoder and a connection module mounted to a video camera. The video/audio encoder includes a connection interface for receiving the audio/video data, a digital signal processor for encoding the audio/video data, and a network interface for coupling the video/audio encoder to a network, such as the Internet. The connection module mounts the video/audio encoder to the video camera and provides an electronic interface to the camera to transfer the audio/video data from the camera to the video/audio encoder through the connection interface. A remote controller including a user interface enables the addition of metadata to the audio/video file over a personal area network connection.

### CROSS-REFERENCE TO RELATED APPLICATIONS

This application claims priority to and the benefit of provisional patent application No. 61/076,597, filed in the United States Patent and Trademark Office on Jun. 27, 2008, the entire content of which is incorporated herein by reference.

### BACKGROUND

1. Field

The following disclosure generally relates to audio/video (A/V) systems for broadcasting information over the Internet.

2. Description of the Related Art

Conventional television studios utilize sophisticated control rooms full of equipment to change angles between studio cameras, field cameras, pre-cut video and other video sources. The rooms have equipment to turn up the volume of microphones, cue music, and add graphics over the top of their broadcast that viewers watch on their TVs. A TV studio's control room typically has an entire wall of video monitors to view all the different feeds, videotape playback, studio & field cameras and other kinds of signals that are feeding into it. A control room has the ability to switch between all different sources of video signals using a video switcher.

While video/audio encoders for recording, encoding, and storing audio/video data have existed in the marketplace many years now, they are typically large, heavy and require large amounts of power that makes them impractical for use in the field. They are also generally too large to mount on a camera. Some drawbacks of conventional systems include being tied down to a location with cables and/or having to use licensed microwave technology to link back to a production truck that then has to send the signal back to the studio over a another licensed microwave signal.

Another conventional alternative, that is, the use of a satellite truck to send a live transmission can be costly, upwards of $12,000 an hour. Further, using the satellite truck requires more expensive equipment at the other end to decode the transmission, record it and get the content into edit bays, studios or to the Internet.

Some other conventional approaches to distribute live audio/video data through the Internet utilize a laptop coupled to a camera, but the limitations to this approach are numerous. For example, having a camera tethered to a laptop is cumbersome and clunky, making it difficult to get the shot if the camera operator has to move quickly. Further, a laptop may easily become disconnected from the camera due to the short lengths of available cable. Moreover, it is difficult for one person to monitor the transmission while operating the camera. Having two people in such close proximity can prove to be a challenge as well.

### SUMMARY

Aspects of exemplary embodiments of the present invention provide turn-key solutions for live Internet video/audio broadcasting and the transferring of previously recorded material. In one aspect, a compact, camera-mountable video/audio encoder is provided for the live broadcast and transferal of previously recorded material. In another aspect, a rack-mountable video/audio encoder is provided for the live broadcast and the transferal of previously recorded material to the Internet. In another aspect, a compact configuration device is provided for interfacing and interacting with the encoder on location.

Further aspects of exemplary embodiments of the present invention provide for a broadcast network and website enabling a user to register, configure and control the video/audio encoder. In some embodiments, the network and website route, record, and redistribute some or all live video/audio signals. In some embodiments, previously recorded material is transferred to and/or downloaded from the network and website. In some embodiments, the user chooses from among multiple sources before sending out a final signal to viewers.

A system according to an exemplary embodiment shares audio/video data over a network by utilizing a compact, camera-mountable video/audio encoder and a connection module mounted to a video camera. The video/audio encoder includes a connection interface for receiving the audio/video data, a digital signal processor for encoding the audio/video data, and a network interface for coupling the video/audio encoder to a network, such as the Internet. The connection module mounts the video/audio encoder to the video camera and provides an electronic interface to the camera to transfer the audio/video data from the camera to the video/audio encoder through the connection interface. A remote controller including a user interface enables the addition of metadata to the audio/video file over a personal area network connection.

In some embodiments, the connection module includes a first mounting apparatus for mounting the connection module onto the camera, and a second mounting apparatus for mounting the video/audio encoder to the connection module. The first mounting apparatus may fasten the connection module to an accessory shoe on the camera.

In some embodiments, the video/audio encoder includes a user interface for enabling a user to interact with the video/audio encoder, a power supply for providing electrical power to the video/audio encoder, a wireless personal area network (PAN) interface for communicating with one or more wireless peripheral devices, such as the remote controller, and a control unit for controlling the video/audio encoder.

In some embodiments, the remote controller includes its own user interface for enabling a user to interact with the remote controller, its own power supply, and its own control unit. The user interface on the remote controller may include a display device and a keypad. The display device may be configured to display information corresponding to a status of the video/audio encoder. Further, the remote controller may be configured to selectively add metadata to the audio/video data in the video/audio encoder in accordance with user input utilizing the user interface.

A backup power supply may provide a secondary power supply to the video/audio encoder. A global positioning system (GPS) unit may be included in the video/audio encoder for determining a position of the video/audio encoder. Further, a system clock may be included in the video/audio encoder for keeping time to be appended to the audio/video file.

In some embodiments, an archive server is coupled to the network for receiving and storing the audio/video data, and for providing access to the stored audio/video data to users of a website.

In another exemplary embodiment, a process for distributing audio/video content over a network includes capturing the audio/video content with a video camera, transferring the audio/video content to a video/audio encoder mounted on the video camera, and encoding the audio/video content into an encoded audio/video file. The audio/video file including any metadata appended thereto is stored in a nonvolatile memory unit in the video/audio encoder as a local copy. The audio/video file is transferred over a network interface coupled to a network, and an archive server stores a remote copy of the transmitted audio/video file. The remote copy is verified by comparing it to the local copy.

These and other aspects of the invention are more fully comprehended upon review of this disclosure.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram of a system for creating and distributing audio/video content according to an exemplary embodiment of the present invention.

FIG. 2 is a block diagram illustrating a video/audio encoder according to an exemplary embodiment of the present invention.

FIG. 3 is a block diagram illustrating a remote controller according to an exemplary embodiment of the present invention.

FIGS. 4-5 are illustrations of video/audio encoders mounted onto video cameras according to exemplary embodiments of the present invention.

FIG. 6 is a flowchart illustrating a process of creating and distributing audio/video content according to an exemplary embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “connected” or “coupled” to another element, it can be directly connected or coupled to the another element or be indirectly connected or coupled to the another element with one or more intervening elements interposed therebetween. Like reference numerals designate like elements throughout the specification.

Conventional video broadcasting websites, while popular, lack the capability for users to send or receive a live broadcast of video/audio data such as special occasions, pre-planned events, or even amateur news coverage. According to an exemplary embodiment of the present invention, a website provides this capability. The website according to the embodiment allows video broadcasters to send their broadcasts by providing infrastructure suitable to handle both the overhead of millions of broadcasters as well as that of millions of viewers. The website according to the embodiment further provides a geographical map that integrates with the GPS of the video/audio encoder to place markers on the map, along with descriptions of the type broadcast and its content.

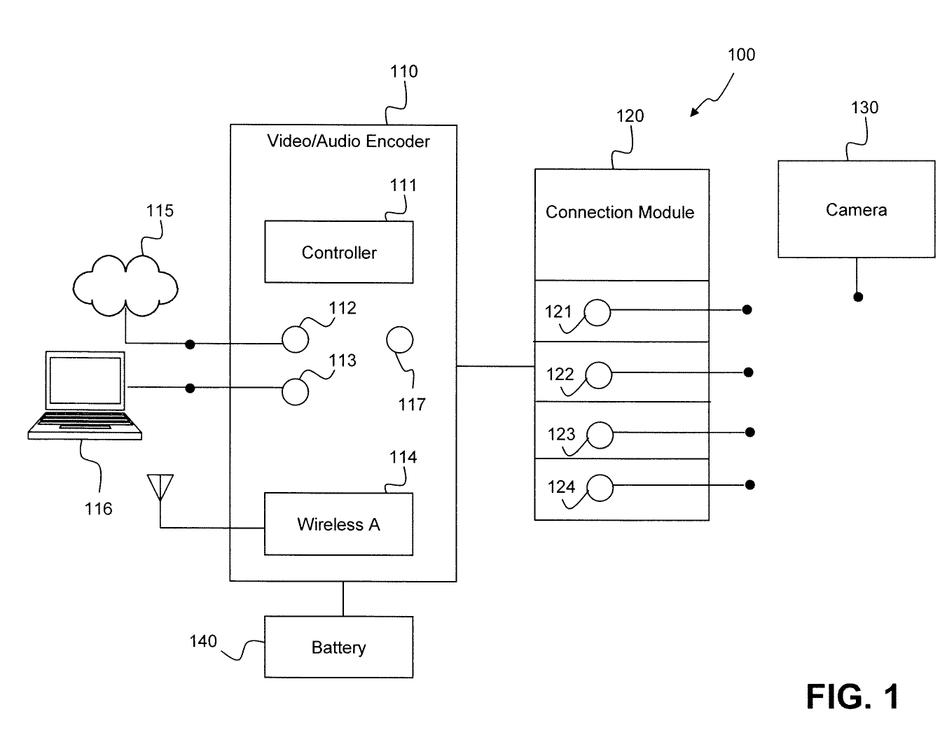

FIG. 1 illustrates a system 100 utilizing a video/audio encoder 110 and a connection module 120 according to an exemplary embodiment. In some embodiments, the video/audio encoder 110 is a compact, camera mountable device mounted to a camera 130 utilizing the camera's accessory shoe and/or a custom made mount that attaches (e.g., on the bottom) to any digital video camera 130. In some embodiments, a rack-mountable video/audio encoder 110 provides greater space for a longer usable life, a larger storage capacity, more powerful computing, or other benefits as a trade-off against the portability of a camera-mountable video/audio encoder.

The video/audio encoder 110 includes a controller 111 for controlling the various peripherals within the device, one or more network interfaces 112 for interfacing with a network 115, and one or more user interfaces 113 for interfacing with a user through, for example, a keyboard 116. In various embodiments, the controller 111 is a microcontroller unit (MCU), an application specific integrated circuit (ASIC), or any other suitable controller as would be understood by those skilled in the art. In some embodiments, the network interface 112 is a high-bandwidth wireless interface such as a cellular interface, or any other broadband wireless telecommunications interface, for enabling real-time streaming upload of encoded video/audio data to the network 115. In other embodiments, the network interface 112 is an optical and/or wired interface such as a direct cable connection to the Internet. In some of these embodiments, the network interface 112 enables the user to make phone calls using voice over internet protocol (VOIP). Further, some embodiments include an external battery 140 for powering the video/audio encoder 110. Some embodiments include an internal battery 117 within the video/audio encoder as a backup for the external battery 140.

The connection module 120 enables the user to attach a suitable signal interface to the video/audio encoder 110, which enables the encoder to be used with a variety of video/audio sources. In the illustrated embodiment, the connection module 120 includes one or more of four interfaces 121-124, including an analog module 121 (e.g., RCA) for connecting to conventional cameras and/or audio/video equipment with an analog output, a professional-analog module 122 (BNC & XLR Connections) for connecting to conventional professional-quality cameras and/or audio/video equipment with an analog output, a digital module 123 (e.g., Firewire IEEE 1394 and/or HDMI), and a professional-digital module 124 including a serial digital interface (SDI) or a high-definition serial digital interface (HD-SDI). Some embodiments include other suitable interface modules known to those skilled in the art. In some embodiments, a plurality of interchangeable connection modules 120 each include one interface, allowing a user to interchange a smaller connection module 120 as needed to interface with any suitable video/audio collection device. Referring again to FIG. 1, one of the interfaces 121-124 is coupled to a camera 130 for collecting video/audio information.

Some embodiments of the connection module 120 also function as a mounting unit for mounting the video/audio encoder 110 to the camera 130. That is, in an exemplary embodiment, a portion of the connection module 120 physically conforms to a mounting apparatus on the camera 130, such as a standard accessory shoe, concurrently with providing a communications interface between the video/audio encoder 110 and the camera 130. In another exemplary embodiment, the connection module 120 includes a custom mounting apparatus for mounting the video/audio encoder 110 to a professional quality camera 130, for example for professional news gathering applications. Some embodiments of the video/audio encoder 110 are fully integrated into the camera 130 itself, eliminating the need for mounting.

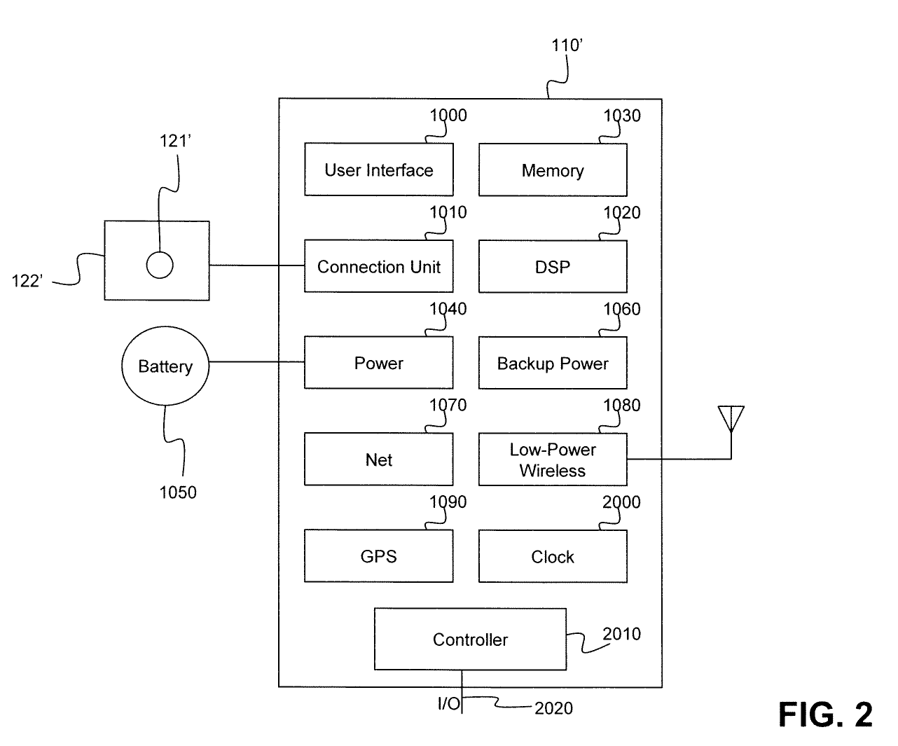

FIG. 2 is a block diagram showing a video/audio encoder 110′ according to another exemplary embodiment of the present invention including a number of peripheral devices, although it is to be understood that various embodiments may not include each and every one of the peripheral devices illustrated in FIG. 2. In FIG. 2, the video/audio encoder 110′ includes a user interface 1000. In some embodiments, the user interface 1000 is a liquid crystal display (LCD) or other suitable display device. In some of these embodiments, the display is a touch screen display device enabling both touch input and video output capabilities. In some embodiments, the user interface 1000 is a plug or other electronic coupling interface for connecting external input/output devices such as a monitor or external display device and/or a keyboard. The user interface 1000 according to various embodiments can be any number of various forms of user interface including, but not limited to a push-button keyboard, a touch-screen, a visual display, and/or audio feedback.

The video/audio encoder 110′ includes a connection unit 1010 for connecting to either a modular connection module, such as the connection module 120 illustrated in FIG. 1, or in other embodiments, for connecting directly to a video/audio recording/sensing device such as the camera 130 illustrated in FIG. 1. In FIG. 2, the connection unit 1010 is a connection interface for connecting to a connection module, such as the connection module 120′. Connection module 120′ includes an analog module 121′, although, as described above, the connection module 120′ may include any of a number of other modules for connecting to any number of cameras and/or audio/video equipment. In some embodiments, the connection unit 1010 is configured to provide for audio/video output, as well as input, so that recorded audio/video data stored in the video/audio encoder 110′ is transmitted out to an external audio/video playback device such as a monitor or screen. According to various embodiments, the connection unit 1010 includes suitable hardware and configuration as one having ordinary skill in the art would readily comprehend for encoding the audio/video output data into an appropriate video format such as NTSC, ATSC, and/or PAL.

The video/audio encoder 110′ includes a digital signal processor (DSP) 1020 for encoding the incoming digital signal from the connection unit 1010. According to various embodiments, the DSP 1020 functions as a video encoder to encode and/or compress data into an appropriate format for storage and wireless transmission. One skilled in the art will comprehend that the DSP 1020 is not limited to any particular method of encoding or compressing video data. Some conventional formats to which the DSP 1020 encodes the data according to various embodiments include WMV 9 (codec: h.264 and VC1), MPEG4 (codec: h.264), and/or Flash Video (codec: h.264). Windows Media Video 9 is a video format capable of achieving high quality video compressed into a small file or transmission data rate. Additional methods of compression utilize the “h.264” and “VC1” codecs known to those skilled in the art, although the skilled artisan will comprehend that the DSP 1020 within the video/audio encoder 110′ is not limited to any particular codec.

The video/audio encoder 110′ includes a memory unit 1030. In some embodiments, the memory unit 1030 includes a non-volatile memory unit, such as a magnetic storage hard disk, a solid state disc (SSD), or any other suitable non-volatile memory device known to those skilled in the art. The memory unit 1030 stores the operating system, encoding software, user interface software, and any other software for operation of the video/audio encoder 110′. The memory unit 1030 further stores video and/or audio recording data. In some embodiments, the video and/or audio recording data is stored in a separate drive from the software for operating the video/audio encoder 110′.

The video/audio encoder 110′ includes a power supply unit 1040. In some embodiments, the power supply unit 1040 includes an internal battery. In some embodiments, the power supply unit 1040 includes an interface to an external power supply, such as an external battery 1050. In some embodiments, the power supply unit 1040 includes one or more of each of an internal battery and/or an interface to an external power supply. According to an exemplary embodiment, the power supply for the video/audio encoder 110′ is an internal lithium ion battery providing an operational lifetime of 10 hours or more. According to another exemplary embodiment, the video/audio encoder 110′ includes an AC line power adapter and a transformer for use when a broadcaster is close to such a source, thus reducing the dependency on battery only power.

In addition to its primary battery, an embodiment of the video/audio encoder 110′ includes a back-up energy storage unit 1060, such as an internal backup battery that will last approximately two minutes enabling the video/audio encoder 110′ to hot swap batteries during a live broadcast. Of course, two minutes is just an example, and the duration may be longer or shorter. This reduces or eliminates the need to shut down the video/audio encoder 110′ with a resultant needed reboot, and prevents the broadcast from going to black during battery switches.

In some embodiments, the video/audio encoder 110′ is fully integrated into a video camera, and the power supply and/or battery is shared with that of the camera itself.

The video/audio encoder 110′ includes a network interface 1070 for coupling the video/audio encoder 110′ to a network. In some embodiments, the network interface 1070 is a modular expansion port, which is configured to allow removal and/or insertion of a separate component for providing a high-bandwidth interface to a network. In some embodiments, the network interface includes an Ethernet interface, a Wi-Fi® interface (Wi-Fi® is a registered trademark of the Wi-Fi Alliance Corporation for certified products based on the IEEE 802.11 standards), a WiMAX™ interface (WiMAX™ is a trademark of WiMAX Forum Corporation for certified products based on the IEEE 802.16 standard), and/or a high bandwidth mobile broadband (e.g., cellular) interface. In some embodiments, the network interface 1070 includes a standard wired communications interface (e.g., USB) for connecting to an external device such as a desktop computer, a laptop computer, or a mobile cellular telephone for connecting to a network. Some embodiments with a standard wired communications interface further utilize this same interface for configuration and/or for uploading and/or downloading audio/video data to and from the video/audio encoder 110′. The video/audio encoder 110′ includes a low-power wireless personal area network (PAN) communications interface 1080, such as a Bluetooth® interface (Bluetooth® is a registered trademark of Bluetooth SIG, Inc. corresponding to IEEE standard 802.15.1) or another suitable low-power communications interface for communicating with a wireless remote controller 150, as described below in further detail. In one embodiment, the network interface 1070 on the video/audio encoder 110′ provides dual functions including that of a wireless network interface or “hot spot,” and that of the PAN interface to communicate with the remote controller 150. That is, in certain embodiments utilizing the Ozmo WiFi protocol (Ozmo Devices™ is a trademark of H-Stream Wireless, Inc.), the same hardware can be utilized in a high-bandwidth mode for communicating with the Internet or other network, and in a low-power mode for communicating with the remote controller 150.

The video/audio encoder 110′ includes a global positioning system (GPS) unit 1090 for geo-tagging video streams with their originating locations. Further, the video/audio encoder 110′ includes a timepiece or system clock 2000 for keeping the time and/or adding a time stamp to the video streams.

The video/audio encoder 110′ includes a controller 2010, such as a microprocessor, an application specific integrated circuit (ASIC), or any other suitable controller as would be understood by those skilled in the art. The controller 2010 is configured with suitable software for general control of the video/audio encoder 110, including various input/output tasks, timing control, data storage and retrieval, and other various tasks one having ordinary skill in the art would comprehend typically being assigned to such a controller 2010. The controller 2010 further includes a general purpose input/output interface (I/O) 2020 for communicating with an external computing device such as a personal computer, a personal digital assistant, or other suitable computing device. The I/O 2020 according to various embodiments includes one or more of a USB, a serial interface, and/or any other suitable communications interface. In some embodiments, the controller 2010 is programmed with an operating system such as any of a number of varieties of open-source operating systems, including embedded Linux. In some embodiments, the DSP 1020 is adapted to function with embedded Linux. However, one skilled in the art will understand that the invention is not limited to any particular operating system.

Referring back to FIG. 1, in an exemplary embodiment, for initial setup, configuration, and/or activation of the video/audio encoder 110, a broadcaster connects the video/audio encoder 110 to a personal computing device such as a laptop or desktop computer via a USB cable (e.g., coupled through the general purpose I/O interface 2020 in FIG. 2) to run software having a configuration wizard that sets up the video/audio encoder through a series of questions. The wizard adds broadcaster account information onto the video/audio encoder 110 and a main website identifying a broadcaster account to which the video stream should be sent, and from there, letting the broadcaster choose which type of broadcast it is, i.e., public, private, or third party. Other embodiments do not require the software to run the configuration program, but rather, enable a user to log directly onto the main website to create an account and enter a unique identifying number corresponding to a particular video/audio encoder 110. In this embodiment, the configuration information is then uploaded to the video/audio encoder 110 via an Internet connection, for example, by way of the network interface 1070. Once activated, the device is locked to a broadcaster and an account that that broadcaster creates on the main website.

That is, an exemplary embodiment provides for a code from the factory to be encoded into each video/audio encoder 110. Once a broadcaster completes the account set-up for a particular video/audio encoder, that factory code will be locked to that particular broadcaster. This helps create broadcaster accountability. However, should a broadcaster wish to transfer ownership of the device to another person, the broadcaster contacts customer support, and once their identity has been verified or established, a code is issued to the new user. In some embodiments, entering this new code resets the device back to factory defaults. Should a broadcaster lose or have a video/audio encoder 110 stolen, they should first disable the device in their account at the main website, and then report the device stolen. In embodiments including a GPS unit 1090, the user is able to track and locate the device when it is turned on.

An exemplary embodiment provides for simplified configuration for a pre-planned broadcast. For a preplanned event the broadcaster can log onto their account on the main website and enter their metadata and other settings for a planned broadcast that is scheduled to happen. This information is then sent to the video/audio encoder 110 over the network 115. Thus, the configuration information appears in a configuration menu on the user interface 113 that the broadcaster can select and immediately start broadcasting without any additional setup.

In some embodiments, the user interface 113 is an embedded LCD interface with touch-screen functionality. In some embodiments, the user interface 113 includes an external device such as a personal computer having a keyboard and monitor, electrically coupled to the video/audio encoder 110. In one embodiment, the user interface 113 is a website application that enables the user to monitor and configure the video/audio encoder 110 via any suitable web browser, such as, but not limited to Microsoft Internet Explorer or Firefox. The display on the user interface 113 displays recorded and/or live video, includes configuration options and displays status, and enables editing of audio/video data stored in the memory (e.g., memory 1030 in FIG. 2). The user interface 113 further displays content categories that are added to the broadcast by touching various icons. The selection of a particular content category adds corresponding metadata that describes various characteristics of the broadcast event to help viewers identify the content for which they are searching. The ability to scroll through categories and tags rapidly enables the broadcaster can add the metadata to the broadcast as quickly as possible, while still quickly being able to go live.

According to one embodiment, the main website and the video/audio encoder 110 remain in constant contact, wherein the website updates the viewer with respect to the status of the video/audio encoder 110 with a preview of the live audio/video data stream on the website. Concurrently, the website pushes broadcast data to the video/audio encoder 110, thereby enabling the broadcaster to choose which category of broadcast they are doing and use those settings. In some embodiments, a second broadcaster working from another location, but in tandem with the broadcaster in the field, edits metadata corresponding to the live broadcast as it happens.

An exemplary embodiment provides for rapid configuration for “breaking news” situations. In a breaking news situation, it may be critical for the broadcaster to go live as soon as possible. In this scenario the configuration includes pre-configured categories from which the broadcaster selects by utilizing menus on the user interface 113 of the video/audio encoder 110. In an embodiment where the user interface 113 is an LCD touch screen, a list of categories is displayed including news, sports, music, etc., with each category further broken down from a primary to secondary, and so on. The broadcaster is provided the ability to “tag” a video with one or more of different predefined keywords, enabling the broadcaster to add as much metadata to the broadcast as possible, while getting the camera ready to shoot in a very short timeframe. The more metadata that the broadcaster can add to each broadcast, the easier it is for the viewer to find what broadcast they want to watch. A broadcaster is further enabled to later log onto their account at the main website and add/change the metadata in the archive, adding more detail and a better description to help the viewer watch the archived video.

In one embodiment, a scrolling interface includes menus to enable broadcasters to select pre-defined broadcast categories that had been previously configured on the broadcaster website and sent to the video/audio encoder 110 or added via the remote controller configuration device described in more detail below. This feature enables the broadcaster to use a suitable user interface, such as a touch screen utilizing quick touch menus, for rapid configuration.

An exemplary embodiment of the video/audio encoder 110 is configured to function in two modes: a “Live To Web” mode and a “Record and Send” mode.

In a first mode, called a “Live To Web” mode for ease of description, a high quality audio/video signal is transmitted to the network 115 via a suitable network connection, as described above. In the Live to Web mode, the video/audio encoder 110 records a live audio/video signal to its internal non-volatile memory (e.g., memory 1030 in FIG. 2). The recording is stored in the non-volatile memory until the user transfers the file to a server (e.g., a predetermined server) connected to the network 115. In some embodiments, the recording file stores a time code to enable synchronization of the file with other material recorded on the camera's tape system. That is, as illustrated in FIG. 2, the system clock 2000 is configured to synchronize the video/audio encoder 110′ to a time server on the network 115 to synchronize a plurality of video/audio encoders 110 in use by broadcasters to a single time stamp, adjusting for time zones, but maintaining synchronization with each other. This enables all cameras, regardless of broadcaster, to keep the broadcasts in sync with one another.

That is, in one embodiment, a plurality of video/audio encoder devices 110 sync to a master time clock on the network 115 to both time stamp and sync video signals together. In this embodiment, the video/audio encoders 110 sync to this master clock, which resides on a centralized time server. Synchronizing the clock 2000 in each of the plurality of video/audio encoders 110 enables each of the cameras to be locked together and gives the viewer the ability to switch between camera angles and still remain in sync should there be more than one camera at any one location, even if the broadcasts are coming from different broadcasters.

In a second mode, called a “Record and Send” mode for ease of description, the video/audio encoder 110 enables the user to capture the audio/video signal from the camera 130. After the content has been captured, the user presses a “Send Video To Server” button on the video/audio encoder 110 (or otherwise provides the video/audio encoder 110 with a “Send Video to Server” command via the user interface 113), thus initiating the sending of the captured file to a sever location on the network (e.g., the Internet) for downloading at the studio for editing or re-broadcasting. Some embodiments further enable the user to do simple “in and out” edits, create smaller clips and thus smaller files, and send the smaller clips/files from a queue of data files stored in the video/audio encoder 110 via the network interface 112. In some embodiments, the video/audio encoder 110 is configured automatically to transfer the recorded audio/video data to a video archive server on the network 115 at the conclusion of the broadcast.

In some embodiments, when a user decides that only a portion of the recorded audio/video data is needed back at the studio and wishes to have only those portions of the content transmitted back, the video/audio encoder 110′ includes a feature called “Simple Edit ‘N’ Send™” for ease of description. The Simple Edit ‘N’ Send™ feature is a time saving feature that enables the user to select the in and out points on a clip, create a new, smaller, more portable clip, and send just the selected clips back to the studio. This feature enables a user to upload clips more quickly, because there is less to send.

In some embodiments, the Record and Send mode further includes concurrently recording audio/video data to the internal memory and recording the audio/video data to a tape, either internal or external to the video/audio recorder 110, wherein each of the recorded data include synchronous time stamps for matching their record times. The recorded video/audio data may be provided by one or more recording devices. This function enables synchronization of the recorded files later for editing usage, and also makes for a good backup in case of tape failure. In some embodiments that combine the Record and Send mode and the Simple Edit ‘N’ Send™ feature, a user is enabled to edit out portions of the audio/video data and/or select portions of the footage in correspondence to the time stamps for quickly sending selected segments back to the studio.

In some embodiments, the GPS unit 1090, illustrated in FIG. 2, facilitates viewers' ability to identify broadcasts on an Internet map according to their locations. Also, the geo tag maintains a level of accountability regarding content and meeting other regulations for the broadcasters. In embodiments where the video/audio encoder 110 is not a mobile device, the GPS unit 1090 is generally omitted. In these embodiments, the location is set in accordance with the IP address of the device, or manually set by the broadcaster.

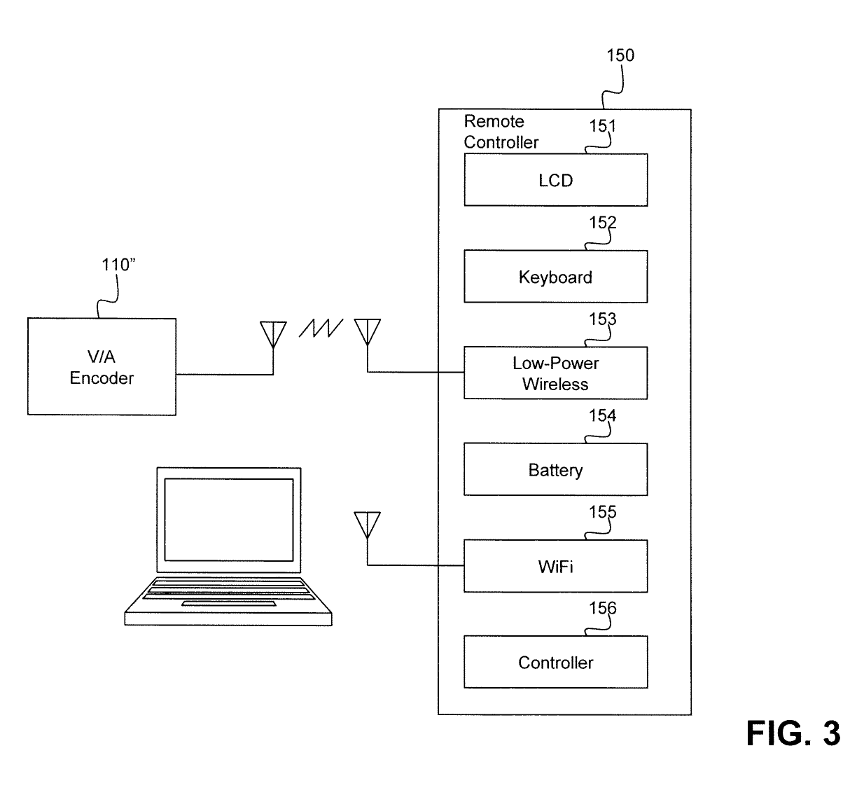

FIG. 3 is a block diagram illustrating an exemplary embodiment including a video/audio encoder 110″ and a remote controller 150 for configuring and controlling the video/audio encoder 110. In some embodiments, the video/audio encoder 110″ is the substantially same as the video/audio encoder 110 illustrated in FIG. 1, and in some embodiments, the video/audio encoder is substantially the same as the video/audio encoder 110′ illustrated in FIG. 2, however, other embodiments may have other variations to the video/audio encoder 110″ within the scope of the present invention.

Returning to FIG. 3, the remote controller 150 according to an exemplary embodiment is a hand-held device that includes a user interface, such as a liquid crystal display (LCD) 151, and/or a slideable “QWERTY” keypad to provide a user interface. In some embodiments, the LCD 151 includes a touch-screen keypad in lieu of the slidable keypad. The remote controller 150 connects to the video/audio encoder 110″ over a suitable wireless data connection. In some embodiments, the wireless connection is controlled by a low-power wireless controller 153 utilizing a wireless driver and antenna for providing a low-power wireless personal area network (PAN) interface such as Ozmo WiFi, Bluetooth®, Zigbee® (Zigbee® is a registered trademark of Zigbee Alliance Corporation, corresponding to IEEE standard 802.15.4), or another suitable protocol as would be known to those skilled in the art. The remote controller 150 further includes a battery 154, a higher-bandwidth wireless data interface 155 (e.g., 802.11 a/b/g/n WiFi), and a controller 156 for storing a control program and for controlling the various peripherals and components of the remote controller 150. In various embodiments, the controller 156 is a microcontroller unit (MCU), an application specific integrated circuit (ASIC), or any other suitable controller as would be understood by those skilled in the art.

Some embodiments of the remote controller 150 include an arm strap for enabling a one-person team to mount the remote controller 150, for example, on the lower part of their left arm if the person is right-handed and the right arm if left-handed. This enables the camera operator to view the status of the video/audio encoder 110″ while shooting.

Further, one skilled in the art will comprehend that other embodiments of the system do not include a remote controller 150, and the video/audio encoder 110″ is controlled locally without any requirement for a remote controller 150. Other embodiments enable a broadcaster to utilize a personal computer or similar device with a low-power wireless PAN interface for communicating with the video/audio encoder 110″ in lieu of a separate remote controller 150.

In embodiments including the remote controller 150, the capability to go live first in a competitive market place is greatly improved. That is, the ability to pre-configure data for a broadcast or do a configuration on the fly, while a broadcast takes place, is provided with the remote controller 150. The remote controller 150 enables a broadcaster to easily add data (metadata) to the broadcast so viewers can find the broadcast on the Internet, potentially giving the broadcaster an edge over competitors.

The remote controller 150 enables a broadcaster to add and configure metadata to append to an audio/video file on the fly, adding text or other suitable information to the stream as information becomes available. In some embodiments, the remote controller 150 includes some or all the configuration options that the video/audio encoder 110″ has, but in other embodiments the remote controller 150 acts like a remote control for a field producer to utilize so the camera operator can focus on the shot.

In some embodiments, the LCD 151 on the remote controller 150 enables the broadcaster to view the camera shot/live stream in real time over the low-power wireless connection 153. That is, the video/audio encoder 110″ is configured to transmit either a full video stream or a compressed and/or otherwise reduced version of the stream over its low power wireless connection (e.g., the low-power wireless unit 1080 illustrated in FIG. 2) to the remote controller 150. In some of these embodiments, the video/audio encoder 110″ further appends information from the network, such as a number of live viewers, to the stream transmitted to the remote controller 150. Thus, the remote controller 150 further enables the broadcaster to monitor how many people are watching the streaming via a live feedback feature incorporated at the server level.

In some embodiments, the remote controller 150 is configured to append metadata to audio/video data as it is created, including start and end points, in accordance with input from the user via the user interface 152. In these embodiments, the remote controller 150 enables a feature called “Simple Edit ‘N’ Send™” for convenience of description. Thus, a producer is enabled to queue a segment of a recorded audio/video file for later transmission when an Internet connection is available.

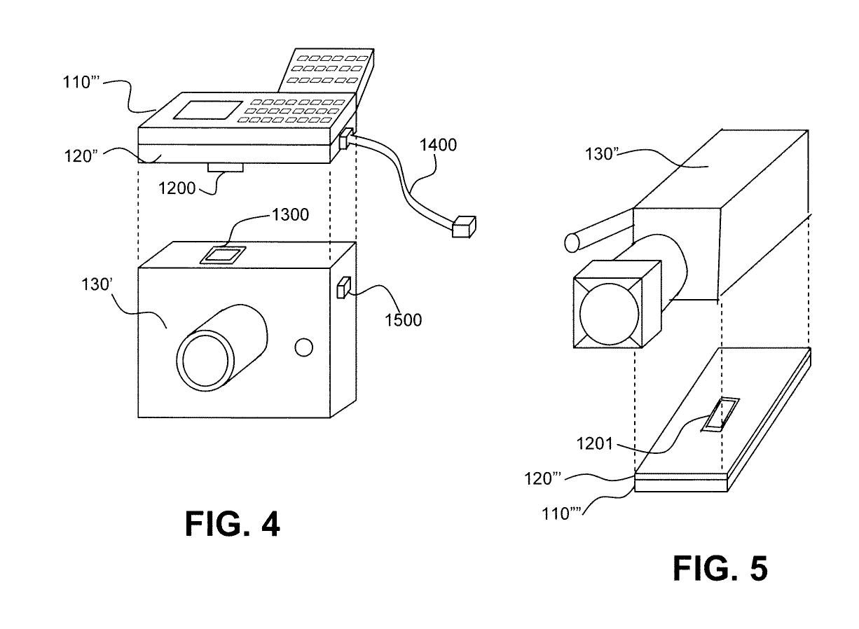

FIGS. 4-5 illustrate exemplary embodiments of systems including a video/audio encoder and a connection module. In FIG. 4, a video/audio encoder 110′″ is mounted to a connection module 120″. In the illustrated embodiment, the connection module 120″ includes a mount 1200 for mounting the connection module 120″ to the accessory shoe 1300 onto a camera 130′. Further, the connection module 120″ includes a mini-USB cable 1400 for providing an electronic interface to a USB camera interface 1500. In FIG. 5, a video/audio encoder 110′″ is mounted to a connection module 120′″. Here, the connection module 120′″ includes a custom mount 1201 for mounting the connection module 120′″ to a bottom side of a professional camera 130″. From these illustrations, it is to be understood that the connection module may take many forms within the scope of this invention.

According to an exemplary embodiment, a virtual control room is provided as a software package for installation on a computing device, such as a personal computer. Video signals that are recorded, encoded, and broadcast over the Internet are routed utilizing the virtual control room software instead of conventional hardware. The video playback that conventionally feeds from an analog videotape deck is instead enabled with a digital file that is cued up and ready to insert into the final broadcast. In some embodiments, additional files are graphics that are overlaid onto the outgoing video stream with the virtual control room software, thus completing the final delivery of broadcast to a website and/or a traditional television broadcast with additional hardware to decode the video stream to an NTSC, ATSC, or PAL signal.

According to an exemplary embodiment for enabling a turn-key audio/video broadcasting solution, a broadcaster logs onto a previously established account at a main website. The main website is not necessarily limited to a particular DNS address, but may include a plurality of aliases, subdomains, or mirror websites. After logging on, the broadcaster monitors incoming video streams from one or more video/audio encoders 110, selectively adds metadata to a video stream, and routes the video stream to the final destination or destinations of the broadcaster's choosing. The broadcaster has a choice of broadcasting directly on the main website, which employs a number of technologies to create a rich viewing experience, or routing their video signal to a third party website or their own website that they have previously set up.

For many broadcasters, the final destination of their broadcast is the main website, which, in some embodiments, utilizes an online geo-map to show the markers to viewers that indicate where different broadcasts are occurring, the markers corresponding to GPS coordinates appended to the broadcast, or an IP address of the broadcasting system for non-mobile video/audio encoders. When a viewer rolls their mouse over a marker, a brief description of the broadcast corresponding to metadata appended to that broadcast appears to help the viewer find content of interest.

The main website provides categories to help viewers narrow down the type of content that appears on the map, and enables keyword searches that look at the metadata provided by the broadcasters to enable the viewer to find specific content and/or broadcasts. Broadcasters have the option to send out invitations via email or otherwise to viewers to invite them to watch their broadcast.

According to another embodiment, the main website enables at least three different types of broadcasters to reach a suitable audience using the video/audio encoder 110: a public broadcaster, a private broadcaster, and a professional broadcaster.

A public broadcaster is a broadcaster who wants their live video stream to be seen by the masses, and is generally not interested in limiting their broadcast to a particular audience. The public broadcaster generally provides their audio/video stream to the main website without restrictions.

Much like the public broadcaster, the private broadcaster generally sends their video stream to the main website, but the private broadcaster marks the stream as private, making it invisible to the public. A broadcast from a private broadcaster does not appear on the geo-map for public viewing. The private broadcaster sends invitations to people that they want to watch their private broadcast. Typical applications for a private broadcaster include events such as weddings, graduations, corporate meetings, etc. In one embodiment, the private broadcasting service is free to the broadcaster and to the viewers. Revenue is generated for the administrator of the main website via ads that on the site in proximity to the video, or embedded into the video. According to this embodiment, the private broadcaster has an option of paying a small premium to have their private broadcast advertisement free.

The professional broadcaster typically broadcasts a live video stream back to their own website. That is, the professional broadcaster utilizes a professional account and pays a premium for the ability to route the video to a third party website other than the front end of the main website. In some embodiments, the professional broadcaster utilizes the main website to control the video stream, the metadata appended to the video stream, and the final destination of the video stream. In some embodiments, a component of the professional broadcaster's fee ensures that the main website does not place advertisements on the professional broadcaster's video stream.

In addition to the streaming of live video to the main website, an exemplary embodiment transmits the audio/video stream to a video archive server where the stream is stored, so that viewers can later go back and watch or download a previously broadcasted event.

In one embodiment, a High Quality (HQ) local recording is stored as an encoded file on a Solid State Disc (SSD) drive on the video/audio encoder 110. As described above, according to various embodiments, the encoded audio/video file is transferred to the video archive server as a live stream, at the conclusion of the broadcast, or at any time that the broadcaster instructs the video/audio encoder 110 to upload the file.

Local recording in addition to recording the live stream on a remote video archive server is desirable because most or all wireless broadcasts are subject to occasional outside interference, and may not always transmit a consistent signal. This backup recording improves the likelihood that the highest quality audio/video recording is stored on the archive servers. That is, at the end of a live stream broadcast, one embodiment automatically verifies the integrity of the remotely stored recording at the archive server by comparing it to the locally stored recording in the video/audio encoder 110.

The remotely stored recording at the archive server is available for transferring an audio/video recording back to edit-bays in the form of one or more files, via the Internet, that would conventionally feed via satellite. Utilizing the Internet to transfer the archives is desirable for both the quality and cost effectiveness of getting audio/video content transferred long distances to a studio for editing.

A producer may decide that only a portion of the material that was acquired is needed back at the studio for edit and may wish to have only those portions of the content transmitted back. Thus, some embodiments include a feature called “Simple Edit ‘N’ Send™.” This is a time saving feature that enables the broadcaster to select the in and out points on a clip, create a new, smaller, more portable clip, and send just the selected clips back to the studio and/or the archive server. An advantages of using this feature includes getting clips to be uploaded faster, because there is less to send.

Various embodiments of the present invention accomplish distribution of audio/video data recorded by a video/audio encoder 110 according to several methods. While the following description provides a number of exemplary situations and describes how an embodiment accomplishes the goals of a broadcaster and/or a viewer in those situations, one having ordinary skill in the art will comprehend that these examples are not intended to limit the scope of the invention to these examples, but rather are intended as illustrative in nature.

An exemplary embodiment provides for user-generated news. A user-generated news portal on the main website will allow broadcasters to stream live events to the Internet via the video/audio encoder 110. Viewers and/or broadcasters of user-generated news broadcasts are added to an Internet map that displays where the broadcast is originating and what broadcasts are available in a particular area. The embedded metadata describes content type that is broadcasting, which is also searchable by category.

In some of these embodiments, the broadcaster shares in the revenue generated from advertising viewed in correspondence with the user-generated news broadcast by licensing the video to other more traditional broadcast outlets, documentary filmmakers, educational and other outlets that wish to license the footage. The user-generated news portal includes a searchable archive of previous broadcasts. Viewers have an option to leave a rating and comments about one or more broadcasts, creating a popular opinion about the work that each broadcaster does.

Some embodiments provide for a professional news portal. In one of these embodiments, professional news outlets utilize the same service as user-generated news broadcasters, and can be a part of the same map with the geo tags. However, the markers or geo tags corresponding to the professional broadcasters may appear in a different color on the map than those corresponding to the user-generated news broadcasters, and generally reap the benefit of a solid reputation for their organization. The professional news outlets may also have the option of using the main website to setup their transmission, but route it to their own website.

Some embodiments provide for the creation of reality TV shows. In one of these embodiments, reality TV producers utilize a video/audio encoder 110 on one or more of their production cameras to stream a live signal back to their show's website using the archive server and/or the main website according to embodiments of the present invention as the backend. These reality TV producers are thereby enabled to broadcast every moment of the show as it is shot, creating a buzz about the show within the Internet community. Commenting is enabled on the main website or a separate website dedicated to the reality show to create a discussion about the live broadcast. The broadcast is generally a live-only feature with no archiving for user viewing, only archiving for the producers to view and edit as needed. One purpose of the reality TV live broadcast is to promote the network broadcast of the show.

Some embodiments provide for the broadcast of private events. Aimed at the end consumer viewer, these embodiments enable the private event broadcaster to invite people to a private broadcast of an event such as sports, concerts, weddings, etc. These embodiments further include a private archive of the users' video that generally is only accessible to people who are invited to watch the content.

In another embodiment, any category of broadcaster is given the option to pay a premium fee for a “pro account” that enables the broadcaster to use a Content Distribution Network (CDN). By utilizing a CDN, broadcasters' audio/video broadcasts are routed to the broadcaster's website. In some embodiments, broadcasters are enabled to insert their own advertisements or those of third parties into the streaming audio/video broadcast. A CDN enables a substantially larger number of broadcasters and viewers to utilize embodiments of the invention in comparison to embodiments that utilize a single or even a number of remote servers.

In general, a viewer accessing the main website is enabled to view live video broadcasts and/or the archived video for free and on demand.

Viewers are enabled to search for live broadcasts in different areas using a map that displays where broadcasts are taking place via geo tags generated from a GPS chip in the video/audio encoder 110 and appended to the data file as metadata. In some embodiments that utilize a cellular antenna and network, when a GPS signal fails to be established, the signal is triangulated by utilizing cell towers to give a location.

In some embodiments, a brief description of a particular data stream appears on the display when a viewer rolls their mouse over a marker on the map corresponding to the broadcast. Each of the markers on the map is color-coded to help the viewer sort through the different types of broadcast (e.g., sports, music, news, celebrity, etc.). Also, a professional vs. amateur broadcast is identified by color or other indicator, corresponding to metadata indicating whether a broadcast is a professional or an amateur one.

In accordance with metadata appended to a broadcast, including a geo-tag, a viewer can pre-define characteristics of streams that the viewer wishes to be available to switch between, something like changing angles in a studio. In some embodiments, a plurality of encoders are synced to a master clock that enables synchronization of all the broadcasts. Thus, there is substantially no time offset of a single location broadcast, even between different broadcasters. The video appears at the bottom of the player window and animates upwards and downwards, hiding itself when not in use. In one embodiment, small “thumbnail” versions of a plurality of video streams are visible to the viewer, and thus the viewer is enabled to rapidly scroll through each of the live streams and choose one to bring to a large display.

In an embodiment including an auto-tuning feature, a viewer determines what broadcasts are available in a certain area (based on content or on location) by defining the area and/or the content, and the software auto-tunes between broadcasts as they start and stop. In general, a broadcaster does not send a stream at all times. Thus, in order to maintain more consistent content, the software searches for broadcasts based on the parameters set by the viewer and delivers what is available. The viewer then has the option to move onto the next broadcast should they not care for what the auto-tune sends to them.

In yet another embodiment for use by children aged about 9 to 15 years, an educational product utilizes the features of the video/audio encoder 110 to enable a live broadcast utilizing, for example, 1-3 small sturdy cameras with links to a desktop or laptop computer or the Internet with parental approval. This includes the studio software that enables cutting between camera angles with an actual production capability. This embodiment develops children's interest in video production, writing, directing, and broadcasting.

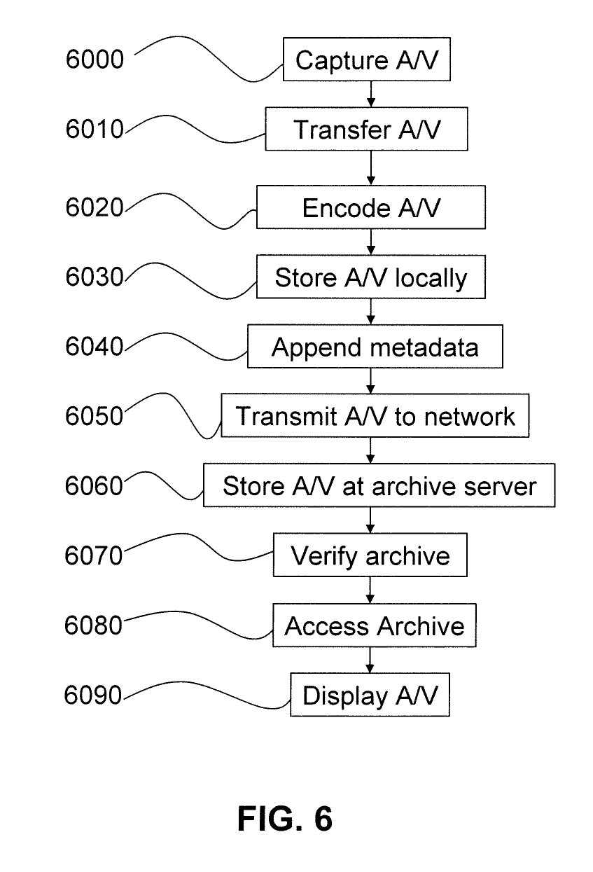

Referring now to FIG. 6, a process according to an exemplary embodiment of the invention will be described in accordance with the illustrated flow chart. In step 6000, audio/video content is captured. In some embodiments, capturing the audio/video content is accomplished by utilizing a conventional consumer-grade video camera, a professional video camera, or generally any model therebetween. Step 6010 includes transferring the audio/video content from the video camera to the video/audio encoder, such as the encoder 110 described above, which mounted on the video camera. In some embodiments, the video/audio encoder is mounted by utilizing a connection module 120, as described above.

In step 6020, the audio/video content is encoded into an encoded audio/video file. According to various embodiments, as described above, encoding the content into a file includes converting raw image and audio data into a format suitable for transmission over a network, with some embodiments including compression of the file into a smaller file format as a part of this step. In step 6030, the encoded audio/video content is locally stored in a nonvolatile memory unit within the video/audio encoder. In step 6040, metadata is appended to the audio/video file. In some embodiments, the metadata is appended on the fly, as the audio/video content is being captured, and stored concurrently with the storage of the audio/video file. In other embodiments, the metadata is appended to the encoded and stored audio/video file at a later time after the encoding and storage has already completed. As described above, the metadata includes any of location data from a GPS unit, an IP address, content descriptive information entered by the user, or essentially any other metadata that the network or a viewer would find useful appended to an audio/video file.

In step 6050, the audio/video file is transmitted through a network interface to a network, such as the Internet. Some embodiments transmit the audio/video file by utilizing a wireless connection such as a cellular or WiMAX™ network. In step 6060, an archive server coupled to the network receives the audio/video file from the network and stores a remote archive copy of the audio/video file. In step 6070, the archive copy is verified, by comparing the archive copy to the local copy stored in the video/audio encoder. In some embodiments, the verification automatically completes at the end of the creation of the content; in other embodiments, the verification is initiated by an explicit instruction by the broadcaster utilizing the video/audio encoder. In steps 6080 and 6090, a viewer utilizing the main website (or a third party website, as described above) accesses the archived copy of the audio/video file, and the website displays the content of the audio/video file to the viewer.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system for sharing audio/video data over a network, comprising:
a video/audio encoder comprising:
a connection interface for receiving audio/video data;
a digital signal processor for encoding the audio/video data;
a nonvolatile memory for storing the audio/video data; and
a network interface for coupling the video/audio encoder to the network; and
a connection module for mounting the video/audio encoder to a camera and for providing an electronic interface to the camera to transfer the audio/video data from the camera to the video/audio encoder through the connection interface.

2. The system of claim 1, wherein the connection module comprises:
a first mounting apparatus for mounting the connection module onto the camera; and
a second mounting apparatus for mounting the video/audio encoder to the connection module.

3. The system of claim 2, wherein the first mounting apparatus is configured to fasten the connection module to an accessory shoe on the camera.

4. The system of claim 1, wherein the video/audio encoder further comprises:
a first user interface for enabling a user to interact with the video/audio encoder;
a first power supply for providing electrical power to the video/audio encoder;
a first wireless personal area network interface for communicating with one or more wireless peripheral devices; and
a first control unit for controlling the video/audio encoder.

5. The system of claim 4, further comprising a remote controller comprising a second wireless personal area network interface for communicating with the first wireless personal area network interface of the video/audio encoder.

6. The system of claim 5, wherein the remote controller further comprises:
a second user interface for enabling a user to interact with the remote controller;
a second power supply for providing electrical power to the remote controller;
a second control unit for controlling the remote controller.

7. The system of claim 6, wherein the second user interface comprises a display device and a keypad.

8. The system of claim 7, wherein the display device is configured to display information corresponding to a status of the video/audio encoder, and wherein the remote controller is configured to selectively add metadata to the audio/video data in the video/audio encoder in accordance with user input utilizing the user interface.

9. The system of claim 1, further comprising:
a backup power supply for providing a secondary power supply to the video/audio encoder;
a global positioning system (GPS) unit for determining a position of the video/audio encoder; and
a system clock for keeping time.

10. The system of claim 9, further comprising:
an archive server coupled to the network for receiving and storing the audio/video data and providing access to the stored audio/video data to users of a website.

11. A video/audio encoder comprising:
a connection interface for receiving audio/video data;
a digital signal processor for encoding the audio/video data;
a nonvolatile memory for storing the audio/video data;
a network interface for coupling the video/audio encoder to a network;
a user interface for enabling a user to interact with the video/audio encoder;
a power supply for providing electrical power to the video/audio encoder;
a backup power supply for proving a backup power supply to the video/audio encoder;
a wireless personal area network (PAN) interface for communicating with peripheral devices on a personal area network;
a global positioning system (GPS) unit for determining a location of the video/audio encoder and providing location data corresponding to the location to be appended to the audio/video data;
a system clock for keeping time and providing time data corresponding to the time to be appended to the audio/video data;
a control unit for executing instructions corresponding to an operating system and for controlling the video/audio encoder; and
a connection module for mounting the video/audio encoder to a camera and for providing an electronic interface to the camera to transfer the audio/video data from the camera to the video/audio encoder through the connection interface.

12. A method of distributing audio/video content over a network, the method comprising:
capturing the audio/video content by utilizing a video camera;
transferring the audio/video content to a video/audio encoder mounted on the video camera;
encoding the audio/video content into an encoded audio/video file;
storing a local copy of the audio/video file in a nonvolatile memory in the video/audio encoder;
appending metadata to the audio/video file;
transmitting the audio/video file over a network interface coupled to a network;
storing a remote copy of the audio/video file at an archive server coupled to the network; and
verifying the remote copy by comparing the local copy with the remote copy.

13. The method of claim 12, wherein the transmitting of the audio/video file over the network interface comprises concurrently storing the local copy of the audio video file and transmitting the audio/video file over the network as a live stream.

14. The method of claim 12, wherein the transmitting of the audio/video file over the network interface comprises automatically transmitting the audio/video file over the network at a completion of the capturing of the audio/video content.

15. The method of claim 12, wherein the verifying of the remote copy comprises automatically verifying the remote copy by comparing the local copy with the remote copy at a completion of the capturing of the audio/video content.

16. The method of claim 12, wherein the appending of the metadata to the audio/video file comprises determining a location of the video/audio encoder utilizing a global positioning system unit and appending data corresponding to the location to the video/audio encoder.

17. The method of claim 12, wherein the appending of the metadata to the audio/video file comprises entering, by a user, data corresponding to the metadata into a user interface on the video/audio encoder.

18. The method of claim 12, wherein the appending of the metadata to the audio/video file comprises entering, by a user, data corresponding to the metadata into a user interface on a remote controller and transferring the metadata from the remote controller to the video/audio encoder over a wireless personal area network interface.

19. The method of claim 12, wherein the appending of the metadata to the audio/video file comprises entering, by a user, data corresponding to a start point and data corresponding to an end point, the start point and the end point corresponding to edit points between which a portion of the audio/video file is to be viewed by a viewer.

20. The method of claim 19, wherein the transmitting of the audio/video file over the network interface comprises transferring a portion of the audio/video file, the portion corresponding to the start point and the end point.

21. The method of claim 12, further comprising:
accessing the archive server by utilizing a website hosted on a computer server;
displaying a map having a marker showing the location of the video/audio encoder corresponding to the audio/video file;
displaying at least a portion of the audio/video file in accordance with a selection of the marker corresponding to the audio/video file.
